(19) United States
(12) Patent Application Publication
(10) Pub. No.: US 2008/0071035 A1
(43) Pub. Date: Mar. 20, 2008

(54) CURABLE POLY(ARYLENE ETHER) COMPOSITION AND METHOD

(76) Inventors: Erik R. Delsman, Breda (NL); Hua Guo, Selkirk, NY (US); Edward N. Peters, Lenox, MA (US)

Correspondence Address: CANTOR COLBURN LLP - SABIC (NORYL), 20 Church Street, 22nd Floor, Hartford, CT, 06103, US

(21) Appl. No.: 11/532,135

(22) Filed: Sep. 15, 2006

(51) Int. Cl. C08L 71/12

(52) U.S. Cl. 525/396

(57) ABSTRACT

A curable composition includes an epoxy resin and a bifunctional poly(arylene ether) having an intrinsic viscosity of about 0.03 to about 0.2 deciliter per gram. After curing, the composition exhibits markedly improved impact strength relative to a corresponding composition prepared from monofunctional poly(arylene ether).

### BACKGROUND OF THE INVENTION

Epoxy resins are high performance materials used in a wide variety of applications including protective coatings, adhesives, electronic laminates (such as those used in the fabrication of computer circuit boards), flooring and paving applications, glass fiber-reinforced pipes, and automotive parts (including leaf springs, pumps, and electrical components). In their cured form, epoxy resins offer desirable properties including good adhesion to other materials, excellent resistance to corrosion and chemicals, high tensile strength, and good electrical resistance. Two challenges associated with the use of epoxy resins are the brittleness of the cured epoxy resins and the need to heat many curable epoxy compositions enough to prepare and blend and shape them but not so much as to cure them prematurely.

With respect to the brittleness problem of epoxy resins, the addition of poly(arylene ether)s to epoxy resins is known to increase the toughness of the cured compositions. For example, U.S. Pat. No. 4,912,172 to Hallgren et al. describes a composition comprising a polyphenylene ether having a number average molecular weight of at least about 12,000 and an epoxy material selected from the group consisting of at least one polyglycidyl ether of a bisphenolic compound, said polyglycidyl ether having an average of at most one aliphatic hydroxy group per molecule, and combinations of a major amount of said polyglycidyl ether with a minor amount of at least one of aryl monoglycidyl ethers and non-bisphenolic polyepoxy compounds. However, relatively high temperatures are required to form homogeneous mixtures of the polyphenylene ether and the epoxy resin.

As another example, U.S. Pat. No. 5,834,565 to Tracy et al. describes compositions comprising a polyphenylene ether having a number average molecular weight less than 3,000 grams per mole, and a thermosetting resin that may be an epoxy resin. The polyphenylene ethers exhibit improved solubility in the curable compositions. However, the products obtained on curing these compositions are not as tough as those prepared with higher molecular weight polyphenylene ethers.

As yet another example, U.S. Pat. No. 7,022,777 B2 to Davis et al. describes compositions comprising a poly(arylene ether), a thermosetting resin, a toughening agent, and an amine cure agent. However, elevated temperatures appear to be required to dissolve the polyphenylene ether. Thus, in Examples 1 and 2, a curable composition was prepared, in part, by adding poly(arylene ether) to a blend of epoxy resin and polyvinyl butyral at 160° C.

Known curable compositions comprising poly(arylene ether)s and epoxy resins thus appear to present a trade-off between ease of preparation and toughness of the cured product. When a high molecular weight poly(arylene ether) is employed, the cured product is very tough, but elevated temperatures are required to dissolve the poly(arylene ether) in the epoxy resin. On the other hand, when a low molecular weight poly(arylene ether) is employed, it is possible to dissolve the poly(arylene ether) in the epoxy resin at a lower temperature, but smaller improvements in toughness are observed in the cured product.

There remains a need for curable epoxy compositions that can be processed at low temperature yet be extremely tough (less brittle) after curing.

### BRIEF DESCRIPTION OF THE INVENTION

The above-described and other drawbacks are alleviated by a curable composition, comprising: an epoxy resin; a bifunctional poly(arylene ether) having an intrinsic viscosity of about 0.03 to about 0.2 deciliter per gram, measured in chloroform at 25° C.; and an amount of a curing promoter effective to cure the epoxy resin; wherein the composition after curing exhibits an unnotched Izod impact strength at least 5% greater than that of a corresponding composition with a monofunctional poly(arylene ether), wherein unnotched Izod impact strength is measured at 25° C. according to ASTM D4812.

Another embodiment is a curable composition, consisting of: an epoxy resin; a bifunctional poly(arylene ether) having an intrinsic viscosity of about 0.03 to about 0.2 deciliter per gram, measured in chloroform at 25° C.; an amount of a curing promoter effective to cure the epoxy resin; optionally, about 2 to about 50 weight percent of a filler, based on the total weight of the composition; and optionally, an additive selected from dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, substrate adhesion agents, mold release agents, toughening agents, low-profile additives, stress-relief additives, and combinations thereof; wherein the composition after curing exhibits an unnotched Izod impact strength at least 5% greater than that of a corresponding composition with a monofunctional poly(arylene ether), wherein unnotched Izod impact strength is measured at 25° C. according to ASTM D4812.

Another embodiment is a curable composition, comprising: a bisphenol A diglycidyl ether epoxy resin; a bifunctional poly(arylene ether) having an intrinsic viscosity of about 0.03 to about 0.2 deciliter per gram, measured in chloroform at 25° C., wherein the poly(arylene ether) has the structure

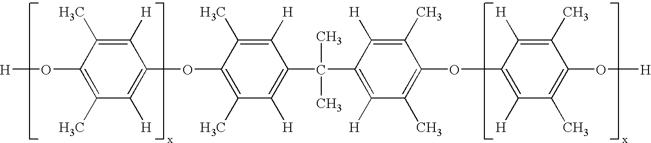

wherein each occurrence of x is independently 1 to about 20; and an amount of a curing promoter effective to cure the epoxy resin; wherein the composition after curing exhibits an unnotched Izod impact strength 5 to about 50% greater than that of a corresponding composition with a monofunctional poly(arylene ether), wherein unnotched Izod impact strength is measured at 25° C. according to ASTM D4812.

Another embodiment is a curable composition, consisting of: a bisphenol A diglycidyl ether epoxy resin; a bifunctional poly(arylene ether) having an intrinsic viscosity of about 0.03 to about 0.2 deciliter per gram, measured in chloroform at 25° C., wherein the poly(arylene ether) has the structure

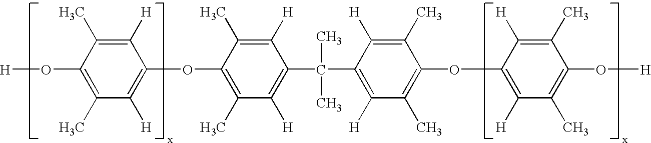

wherein each occurrence of x is independently 1 to about 20; an amount of a curing promoter effective to cure the epoxy resin; optionally, about 2 to about 50 weight percent of a filler, based on the total weight of the composition; and optionally, an additive selected from dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, substrate adhesion agents, mold release agents, toughening agents, low-profile additives, stress-relief additives, and combinations thereof; wherein the composition after curing exhibits an unnotched Izod impact strength 5 to about 50% greater than that of a corresponding composition with a monofunctional poly(arylene ether), wherein unnotched Izod impact strength is measured at 25° C. according to ASTM D4812.

Another embodiment is a curable composition, comprising: about 60 to about 90 parts by weight of a bisphenol A diglycidyl ether epoxy resin; about 10 to about 40 parts by weight of a bifunctional poly(arylene ether) having an intrinsic viscosity of about 0.06 to about 0.12 deciliter per gram, measured in chloroform at 25° C., wherein the poly(arylene ether) has the structure

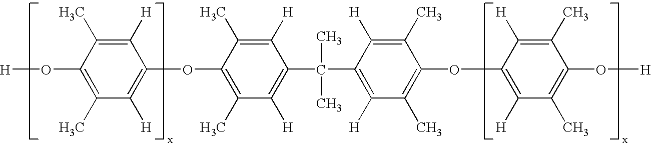

wherein each occurrence of x is independently 1 to about 20; and about 0.5 to about 10 parts by weight of aluminum (III) acetylacetonate; wherein all parts by weight are based on 100 parts by weight total of the epoxy resin and the bifunctional poly(arylene ether); wherein the bisphenol A diglycidyl ether epoxy resin and the bifunctional poly(arylene ether) exist in a single phase at 25 to 65° C.; wherein the curable composition has a viscosity less than or equal to 10,000 centipoise at 25° C.; wherein the composition after curing exhibits an unnotched Izod impact strength 5 to about 50% greater than that of a corresponding composition with a monofunctional poly(arylene ether), wherein unnotched Izod impact strength is measured at 25° C. according to ASTM D4812; and wherein the composition after curing exhibits a notched Izod impact strength 5 to about 30% greater than that of a corresponding composition with a monofunctional poly(arylene ether), wherein notched Izod impact strength is measured at 25° C. according to ASTM D256.

Another embodiment is a composition, consisting of: about 60 to about 90 parts by weight of a bisphenol A diglycidyl ether epoxy resin; about 10 to about 40 parts by weight of a bifunctional poly(alylene ether) having an intrinsic viscosity of about 0.06 to about 0.12 deciliter per gram, measured in chloroform at 25° C., wherein the poly(arylene ether) has the structure

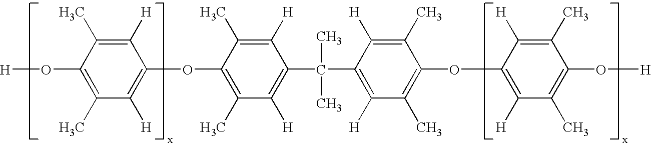

wherein each occurrence of x is independently 1 to about 20; and about 0.5 to about 10 parts by weight of aluminum (III) acetylacetonate; optionally, about 20 to about 100 parts by weight percent of a filler; and optionally, an additive selected from dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, substrate adhesion agents, mold release agents, toughening agents, low-profile additives, stress-relief additives, and combinations thereof; wherein the bisphenol A diglycidyl ether epoxy resin and the bifunctional poly(arylene ether) exist in a single phase at 25 to 65° C.; wherein all parts by weight are based on 100 parts by weight total of the epoxy resin and the bifunctional poly(arylene ether); wherein the composition after curing exhibits an unnotched Izod impact strength 5 to about 50% greater than that of a corresponding composition with a monofunctional poly(arylene ether), wherein unnotched Izod impact strength is measured at 25° C. according to ASTM D4812; and wherein the composition after curing exhibits a notched Izod impact strength 5 to about 30% greater than that of a corresponding composition with a monofunctional poly(arylene ether), wherein notched Izod impact strength is measured at 25° C. according to ASTM D256.

Another embodiment is a curable composition, comprising: about 60 to about 90 parts by weight of a bisphenol A diglycidyl ether epoxy resin; about 10 to about 40 parts by weight of a bifunctional poly(arylene ether) having an intrinsic viscosity of about 0.06 deciliter per gram, measured in chloroform at 25° C., wherein the poly(arylene ether) has the structure

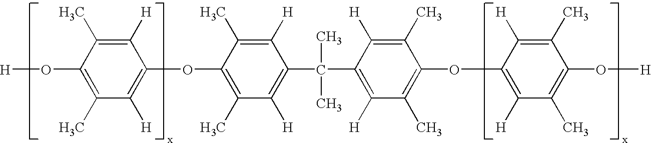

wherein each occurrence of x is independently 1 to about 20; and about 0.5 to about 10 parts by weight of aluminum (III) acetylacetonate; wherein the bisphenol A diglycidyl ether epoxy resin and the bifunctional poly(arylene ether) exist in a single phase at 25 to 65° C.; wherein all parts by weight are based on 100 parts by weight total of the epoxy resin and the bifunctional poly(arylene ether); wherein the composition after curing exhibits an unnotched Izod impact strength 5 to about 50% greater than that of a corresponding composition with a monofunctional poly(arylene ether), wherein unnotched Izod impact strength is measured at 25° C. according to ASTM D4812; and wherein the composition after curing exhibits a notched Izod impact strength 5 to about 30% greater than that of a corresponding composition with a monofunctional poly(arylene ether), wherein notched Izod impact strength is measured at 25° C. according to ASTM D256.

Another embodiment is a curable composition, comprising: about 60 to about 90 parts by weight of a bisphenol A diglycidyl ether epoxy resin; about 10 to about 40 parts by weight of a bifunctional poly(arylene ether) having an intrinsic viscosity of about 0.09 deciliter per gram, measured in chloroform at 25° C., wherein the poly(arylene ether) has the structure

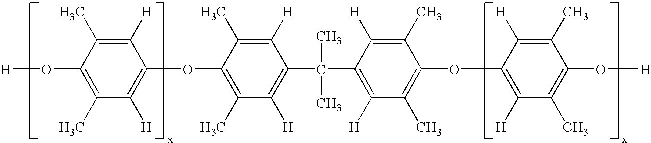

wherein each occurrence of x is independently 1 to about 20; and about 0.5 to about 10 parts by weight of aluminum (III) acetylacetonate; wherein the bisphenol A diglycidyl ether epoxy resin and the bifunctional poly(arylene ether) exist in a single phase at 25 to 65° C.; wherein all parts by weight are based on 100 parts by weight total of the epoxy resin and the bifunctional poly(arylene ether); wherein the composition after curing exhibits an unnotched Izod impact strength 5 to about 50% greater than that of a corresponding composition with a monofunctional poly(arylene ether), wherein unnotched Izod impact strength is measured at 25° C. according to ASTM D4812; and wherein the composition after curing exhibits a notched Izod impact strength 5 to about 30% greater than that of a corresponding composition with a monofunctional poly(arylene ether), wherein notched Izod impact strength is measured at 25° C. according to ASTM D256.

Another embodiment is a curable composition, comprising: about 60 to about 90 parts by weight of a bisphenol A diglycidyl ether epoxy resin; about 10 to about 40 parts by weight of a bifunctional poly(arylene ether) having an intrinsic viscosity of about 0.12 deciliter per gram, measured in chloroform at 25° C., wherein the poly(arylene ether) has the structure

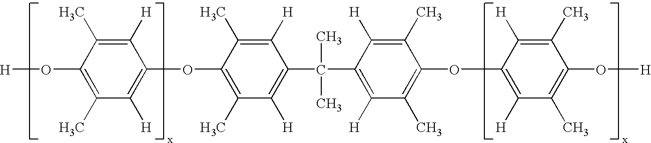

wherein each occurrence of x is independently 1 to about 20; and about 0.5 to about 10 parts by weight of aluminum (III) acetylacetonate; wherein the bisphenol A diglycidyl ether epoxy resin and the bifunctional poly(arylene ether) exist in a single phase at 25 to 65° C.; wherein all parts by weight are based on 100 parts by weight total of the epoxy resin and the bifunctional poly(arylene ether); wherein the composition after curing exhibits an unnotched Izod impact strength 5 to about 50% greater than that of a corresponding composition with a monofunctional poly(arylene ether), wherein unnotched Izod impact strength is measured at 25° C. according to ASTM D4812; and wherein the composition after curing exhibits a notched Izod impact strength 5 to about 30% greater than that of a corresponding composition with a monofunctional poly(arylene ether), wherein notched Izod impact strength is measured at 25° C. according to ASTM D256.

Another embodiment is a method of preparing a curable composition, comprising: blending an epoxy resin, a bifunctional poly(arylene ether) having an intrinsic viscosity of about 0.03 to about 0.2 deciliter per gram, measured in chloroform at 25° C., and an amount of a curing promoter effective to cure the epoxy resin; wherein the composition after curing exhibits an unnotched Izod impact strength at least 5% greater than that of a corresponding composition with a monofunctional poly(arylene ether), wherein unnotched Izod impact strength is measured at 25° C. according to ASTM D4812.

Other embodiments, including cured compositions prepared by curing the curable compositions and articles comprising the cured compositions, are described in detail below.

### DETAILED DESCRIPTION OF THE INVENTION

The present inventors have conducted research on curable poly(arylene ether) compositions in an effort to break out of the previous constraints of poly(arylene ether) solubility in the curable composition versus toughness of the resulting cured resin. In the course of this research, the present inventors have discovered that by using poly(arylene ether) resins having a particular hydroxyl group functionality and a particular molecular weight, the solubility of the poly(arylene ether)s in the curable composition can be improved without sacrificing toughness in the composition after curing. Alternatively, the toughness of the composition after curing can be improved without sacrificing the solubility of the poly(arylene ether)s in the curable composition. Thus, one embodiment is a curable composition, comprising: an epoxy resin; a bifunctional poly(arylene ether) having an intrinsic viscosity of about 0.03 to about 0.2 deciliter per gram, measured in chloroform at 25° C.; and an amount of a curing promoter effective to cure the epoxy resin; wherein the composition after curing exhibits an unnotched Izod impact strength at least 5% greater than that of a corresponding composition with a monofunctional poly(arylene ether), wherein unnotched Izod impact strength is measured at 25° C. according to ASTM D4812.

With respect to an individual poly(arylene ether) molecule, the term “bifunctional” means that the molecule comprises two phenolic hydroxy groups. With respect to a poly(arylene ether) resin, the term “bifunctional” means that the resin comprises, on average, about 1.6 to about 2.4 phenolic hydroxy groups per poly(arylene ether) molecule. In some embodiments, the bifunctional poly(arylene ether) comprises, on average, about 1.8 to about 2.2 phenolic hydroxy groups per poly(arylene ether) molecule.

As noted above, the composition after curing exhibits an unnotched Izod impact strength at least 5% greater than that of a corresponding composition with a monofunctional poly(arylene ether), wherein unnotched Izod impact strength is measured at 25° C. according to ASTM D4812. It will be understood that the “corresponding composition with a monofunctional poly(arylene ether)” refers to a corresponding cured composition prepared from curable composition in which a monofunctional poly(arylene ether) of the same intrinsic viscosity is substituted for the bifunctional poly(arylene ether). In some embodiments, the unnotched Izod impact strength is 5 to about 50% greater than that of a corresponding composition with a monofunctional poly(arylene ether). With respect to an individual poly(arylene ether) molecule, the term “monofunctional” means that the molecule comprises one phenolic hydroxy group. With respect to a poly(arylene ether) resin, the term “monofunctional” means that the resin comprises, on average, about 0.8 to about 1.2 phenolic hydroxy groups per poly(arylene ether) molecule.

Notched Izod impact strengths are also improved. For example, in some embodiments, the composition after curing exhibits a notched Izod impact strength at least 5% greater than that of a corresponding composition with a monofunctional poly(arylene ether), wherein notched Izod impact strength is measured at 25° C. according to ASTM D256. In some embodiments, the notched Izod impact strength is 5 to about 30% greater than that of a corresponding composition with a monofunctional poly(arylene ether).

A variety of epoxy resins are suitable for use in the curable composition. The epoxy resin may be a solid at room temperature. Thus, in some embodiments, the epoxy resin has a softening point of about 25° C. to about 150° C. Softening points may be determined according to ASTM E28-99(2004), “Standard Test Methods for Softening Point of Resins Derived from Naval Stores by Ring-and-Ball Apparatus”. The epoxy resin may be a liquid or a softened solid at room temperature. Thus, in some embodiments, the epoxy resin has a softening point less than 25° C.

Suitable epoxy resins include, for example, aliphatic epoxy resins (including the diglycidyl ether of neopentyl glycol), cycloaliphatic epoxy resins, bisphenol-A epoxy resins, bisphenol-F epoxy resins, phenol novolac epoxy resins, cresol-novolac epoxy resins, biphenyl epoxy resins, polyfunctional epoxy resins, naphthalene epoxy resins, divinylbenzene dioxide, 2-glycidylphenylglycidyl ether, dicyclopentadiene-type epoxy resins, multi aromatic resin type epoxy resins, and combinations thereof. The epoxy resin may be monomeric, oligomeric, or a combination thereof. In some embodiments, the epoxy resin comprises a bisphenol A diglycidyl ether epoxy resin.

In addition to an epoxy resin, the curable composition includes a bifunctional poly(arylene ether). Suitable bifunctional poly(arylene ether)s include those having the structure

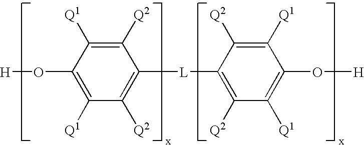

wherein each occurrence of Q¹ and Q² is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of x is independently 1 to about 100; and L has the structure

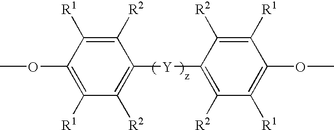

wherein each occurrence of R¹ and R² is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; z is 0 or 1; and Y has a structure selected from

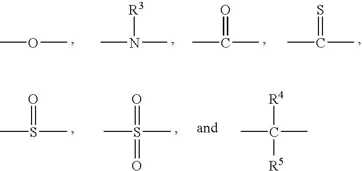

wherein each occurrence of R³ is independently selected from hydrogen and C₁-C₁₂ hydrocarbyl, and each occurrence of R⁴ and R⁵ is independently selected from hydrogen and C₁-C₁₂ hydrocarbyl (including, for example, C₃-C₈ cycloalkyl and phenyl) or R⁴ and R⁵ collectively form a C₄-C₁₂ alkylene group (for example, R⁴ and R⁵ may collectively form an n-pentylene group (that is, a pentamethylene group (—CH₂CH₂CH₂CH₂CH₂—)).

In some embodiments, the bifunctional poly(arylene ether) has the structure

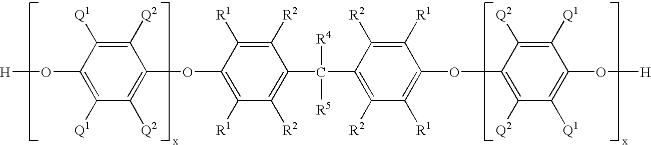

wherein Q¹ is methyl; each occurrence of Q² is independently hydrogen or methyl; each occurrence of R¹ and R² is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; R⁴ and R⁵ are each independently hydrogen or C₁-C₆ hydrocarbyl; and

each occurrence of x is independently 1 to about 50.

In some embodiments, the bifunctional poly(arylene ether) has the structure

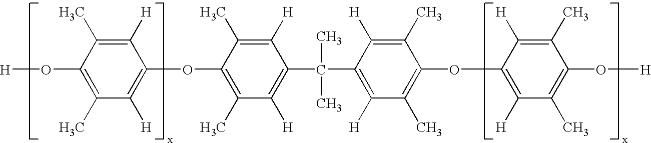

wherein each occurrence of x is independently 1 to about 20.

Bifunctional poly(arylene ether)s may be prepared, for example, by oxidative copolymerization of a monohydric phenol and a dihydric phenol. Suitable monohydric phenols include, for example, 2,6-dimethylphenol, 2,3,6-trimethylphenol, and the like, and mixtures thereof. Suitable dihydric phenols include, for example, 3,3′,5,5′-tetramethyl-4,4′-biphenol, 2,2-bis(3-methyl-4-hydroxyphenyl)propane, 2,2-bis(3,5-dimethyl-4-hydroxyphenyl)propane, 1,1-bis(4-hydroxyphenyl)methane, 1,1-bis(4-hydroxyphenyl)ethane, 2,2-bis(4-hydroxyphenyl)propane 2,2-bis(4-hydroxyphenyl)butane, 2,2-bis(4-hydroxyphenyl)octane, 1,1-bis(4-hydroxyphenyl)propane, 1,1-bis(4-hydroxyphenyl)-n-butane, bis(4-hydroxyphenyl)phenylmethane, 1,1-bis(4-hydroxy-3-methylphenyl)cyclohexane, 1,1-bis(4-hydroxy-3,5-dimethylphenyl)cyclopentane, 1,1-bis(4-hydroxy-3,5-dimethylphenyl)cyclohexane, 1,1-bis(4-hydroxy-3-methylphenyl)cycloheptane, 1,1-bis(4-hydroxy-3,5-dimethylphenyl)cycloheptane, 1,1-bis(4-hydroxy-3-methylphenyl)cyclooctane, 1,1-bis(4-hydroxy-3,5-dimethylphenyl)cyclooctane, 1,1-bis(4-hydroxy-3-methylphenyl)cyclononane, 11,1-bis(4-hydroxy-3,5-dimethylphenyl)cyclononane, 1,1-bis(4-hydroxy-3-methylphenyl)cyclodecane, 1,1-bis(4-hydroxy-3,5-dimethylphenyl)cyclodecane, 1,1-bis(4-hydroxy-3-methylphenyl)cycloundecane, 1,1-bis(4-hydroxy-3,5-dimethylphenyl)cycloundecane, 1,1-bis(4-hydroxy-3-methylphenyl)cyclododecane, 1,1-bis(4-hydroxy-3,5-dimethylphenyl)cyclododecane, 1,1-bis(4-hydroxy-3-t-butylphenyl)propane, 2,2-bis(4-hydroxy-2,6-dimethylphenyl)propane 2,2-bis(4-hydroxy-3-bromophenyl)propane, 1,1-bis(4-hydroxyphenyl)cyclopentane, 1,1-bis(4-hydroxyphenyl)cyclohexane, and mixtures thereof. In some embodiments, the bifunctional poly(arylene ether) is prepared by oxidative copolymerization of 2,6-dimethylphenol and 2,2-bis(3,5-dimethyl-4-hydroxyphenyl)propane.

In some embodiments, the bifunctional poly(arylene ether) comprises a polysiloxane segment. For example, the bifunctional poly(arylene ether) may have the structure

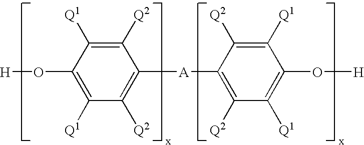

wherein each occurrence of Q¹ and Q² is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of x is independently 1 to about 100; and A has the structure

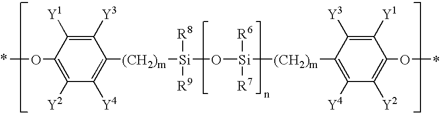

wherein each occurrence of R⁶ and R⁷ and R⁸ and R⁹ is independently hydrogen, C₁-C₁₂ hydrocarbyl or C₁-C₁₂ halohydrocarbyl; wherein each occurrence of m is independently 0, 1, 2, 3, 4, 5, or 6; and wherein each occurrence of Y¹ and Y² and Y³ and Y⁴ is independently hydrogen, C₁-C₁₂ hydrocarbyl, C₁-C₁₂ hydrocarbyloxy, or halogen; and wherein n is 5 to about 200. In some embodiments, each occurrence of Q¹ is methyl, wherein each occurrence of Q² is hydrogen or methyl, wherein each occurrence of Y¹ is methoxy, wherein each occurrence of Y² and Y³ and Y⁴ is hydrogen, each occurrence of R⁶ and R⁷ and R⁸ and R⁹ is methyl, each occurrence of m is 3, and n is about 10 to about 100. Poly(arylene ether)s having internal polysiloxane segments can be prepared, for example, by oxidative copolymerization of a monohydric phenol and a phenol-terminated polysiloxane. The phenol-terminated polysiloxane itself may be prepared by a hydrosilylation reaction between a silyl hydride diterminated polysiloxane and a compound such as eugenol that has both an aliphatic carbon-carbon double bond and a phenolic hydroxyl group.

The epoxy resin and the bifunctional poly(arylene ether) may be combined over a range of proportions. In some embodiments, the curable composition comprises about 30 to about 99 parts by weight of the epoxy resin and about 1 to about 70 parts by weight of the bifunctional poly(arylene ether), wherein all parts by weight are based on 100 parts by weight total of the epoxy resin and the bifunctional poly(arylene ether). In some embodiments, the curable composition comprises about 60 to about 90 parts by weight of the epoxy resin and about 10 to about 40 parts by weight of the bifunctional poly(arylene ether), wherein all parts by weight are based on 100 parts by weight total of the epoxy resin and the bifunctional poly(arylene ether).

In addition to the epoxy resin and the poly(arylene ether), the curable composition comprises an amount of a curing promoter effective to cure the epoxy resin. Suitable curing promoters include, for example, latent cationic cure catalysts, phenolic hardeners, amine hardeners, copper (II) salts of aliphatic or aromatic carboxylic acids, aluminum (III) salts of aliphatic or aromatic carboxylic acids, copper (II) β-diketonates, aluminum (III) β-diketonates, cycloaliphatic carboxylic acid anhydrides (such as cyclohexane-1,2-dicarboxylic anhydride), borontrifluoride-trimethylamine complex, and combinations thereof.

In some embodiments, the curing promoter is a latent cationic cure catalyst selected from diaryliodonium salts, phosphonic acid esters, sulfonic acid esters, carboxylic acid esters, phosphonic ylides, benzylsulfonium salts, benzylpyridinium salts, benzylammonium salts, isoxazolium salts, and combinations thereof. For example, the curing promoter may be a latent cationic cure catalyst comprising a diaryliodonium salt having the structure

[(R¹⁰)(R¹¹)I]⁺X⁻

wherein R¹⁰ and R¹¹ are each independently a C₆-C₁₄ monovalent aromatic hydrocarbon radical, optionally substituted with from 1 to 4 monovalent radicals selected from C₁-C₂₀ alkyl, C₁-C₂₀ alkoxy, nitro, and chloro; and wherein X⁻ is an anion. In some embodiments, the curing promoter is a latent cationic cure catalyst comprising a diaryliodonium salt having the structure

[(R¹⁰)(R¹¹)I]⁺SbF₆⁻

wherein R¹⁰ and R¹¹ are each independently a C₆-C₁₄ monovalent aromatic hydrocarbon radical, optionally substituted with from 1 to 4 monovalent radicals selected from C₁-C₂₀ alkyl, C₁-C₂₀ alkoxy, nitro, and chloro. In some embodiments, the curing promoter is a latent cationic cure catalyst comprising 4-octyloxyphenyl phenyl iodonium hexafluoroantimonate.

In some embodiments, the curing promoter comprises aluminum (III) acetylacetonate.

The curing promoter may comprise a phenolic hardener. Suitable phenolic hardeners include, for example, novolac type phenol resins, aralkyl type phenol resins, dicyclopentadiene type phenol resins, terpene modified phenol resins, biphenyl type phenol resins, bisphenols, triphenylmethane type phenol resins, and combinations thereof.

The curing promoter may comprise an amine hardener. Suitable amine hardeners include, for example, isophoronediamine, triethylenetetraamine, diethylenetriamine, aminoethylpiperazine, 1,2- and 1,3-diaminopropane, 2,2-dimethylpropylenediamine, 1,4-diaminobutane, 1,6-diaminohexane, 1,7-diaminoheptane, 1,8-diaminooctane, 1,9-diaminononane, 1,12-diaminododecane, 4-azaheptamethylenediamine, N,N′-bis(3-aminopropyl)butane-1,4-diamine, cyclohexanediamine, dicyandiamine, diamide diphenylmethane, diamide diphenylsulfonic acid (amine adduct), 4,4′-methylenedianiline, diethyltoluenediamine, m-phenylene diamine, melamine formaldehyde, tetraethylenepentamine, 3-diethylaminopropylamine, 3,3′-iminobispropylamine, 2,4-bis(p-aminobenzyl)aniline, tetraethylenepentamine, 3-diethylaminopropylamine, 2,2,4- and 2,4,4-trimethylhexamethylenediamine, 1,2- and 1,3-diaminocyclohexane, 1,4-diamino-3,6-diethylcyclohexane, 1,2-diamino-4-ethylcyclohexane, 1,4-diamino-3,6-diethylcyclohexane, 1-cyclohexyl-3,4-dimino-cyclohexane, 4,4′-diaminondicyclohexylmethane, 4,4′-diaminodicyclohexylpropane, 2,2-bis(4-aminocyclohexyl)propane, 3,3′-dimethyl-4,4′-diamiondicyclohexylmethane, 3-amino-1-cyclohexaneaminopropane, 1,3- and 1,4-bis(aminomethyl)cyclohexane, m- and p-xylylendiamine, and mixtures thereof.

The amount of curing promoter will depend on the type of curing promoter, as well as the identities and amounts of the other resin components. For example, when the curing promoter is a latent cationic cure catalyst, it may be used in an amount of about 0.1 to about 10 parts by weight per 100 parts by weight of the epoxy resin. As another example, when the curing promoter is a copper (II) or aluminum (III) beta-diketonate, it may be used in an amount of about 1 to 10 parts by weight, per 100 parts by weight of the epoxy resin.

In addition to the epoxy resin, the poly(arylene ether), and the curing promoter, the curable composition may, optionally, further comprise about 2 to about 50 weight percent of a filler, based on the total weight of the composition. Within this range, the filler amount may be less than or equal to 40 weight percent, or less than or equal to 30 weight percent, or less than or equal to 20 weight percent, or less than or equal to 10 weight percent. In some embodiments, the curable composition is free of any intentionally added filler. In some embodiments, the curable composition is free of inorganic particulate filler.

The composition may, optionally, further comprise one or more additives. Thus, in some embodiments, the curable composition comprises an additive selected from dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, substrate adhesion agents, mold release agents, toughening agents, low-profile additives, stress-relief additives, and combinations thereof.

One embodiment is a curable composition, consisting of: an epoxy resin; a bifunctional poly(arylene ether) having an intrinsic viscosity of about 0.03 to about 0.2 deciliter per gram, measured in chloroform at 25° C.; an amount of a curing promoter effective to cure the epoxy resin; optionally, about 2 to about 50 weight percent of a filler, based on the total weight of the composition; and optionally, an additive selected from dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, substrate adhesion agents, mold release agents, toughening agents, low-profile additives, stress-relief additives, and combinations thereof; wherein the composition after curing exhibits an unnotched Izod impact strength at least 5% greater than that of a corresponding composition with a monofunctional poly(arylene ether), wherein unnotched Izod impact strength is measured at 25° C. according to ASTM D4812.

One embodiment is a curable composition, comprising: a bisphenol A diglycidyl ether epoxy resin; a bifunctional poly(arylene ether) having an intrinsic viscosity of about 0.03 to about 0.2 deciliter per gram, measured in chloroform at 25° C., wherein the poly(arylene ether) has the structure

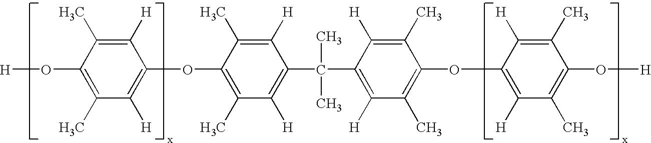

wherein each occurrence of x is independently 1 to about 20; and an amount of a curing promoter effective to cure the epoxy resin; wherein the composition after curing exhibits an unnotched Izod impact strength 5 to about 50% greater than that of a corresponding composition with a monofunctional poly(arylene ether), wherein unnotched Izod impact strength is measured at 25° C. according to ASTM D4812.

One embodiment is a curable composition, consisting of: a bisphenol A diglycidyl ether epoxy resin; a bifunctional poly(arylene ether) having an intrinsic viscosity of about 0.03 to about 0.2 deciliter per gram, measured in chloroform at 25° C., wherein the poly(arylene ether) has the structure

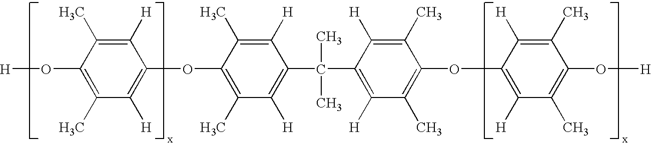

wherein each occurrence of x is independently 1 to about 20; an amount of a curing promoter effective to cure the epoxy resin; optionally, about 2 to about 50 weight percent of a filler, based on the total weight of the composition; and optionally, an additive selected from dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, substrate adhesion agents, mold release agents, toughening agents, low-profile additives, stress-relief additives, and combinations thereof; wherein the composition after curing exhibits an unnotched Izod impact strength 5 to about 50% greater than that of a corresponding composition with a monofunctional poly(arylene ether), wherein unnotched Izod impact strength is measured at 25° C. according to ASTM D4812.

One embodiment is a curable composition, comprising: about 60 to about 90 parts by weight of a bisphenol A diglycidyl ether epoxy resin; about 10 to about 40 parts by weight of a bifunctional poly(arylene ether) having an intrinsic viscosity of about 0.06 to about 0.12 deciliter per gram, measured in chloroform at 25° C., wherein the poly(arylene ether) has the structure

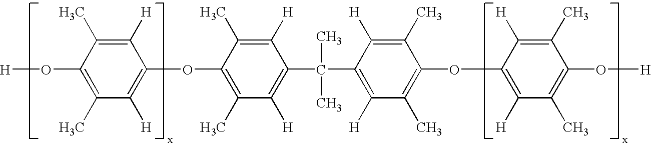

wherein each occurrence of x is independently 1 to about 20; and about 0.5 to about 10 parts by weight of aluminum (III) acetylacetonate; wherein all parts by weight are based on 100 parts by weight total of the epoxy resin and the bifunctional poly(arylene ether); wherein the bisphenol A diglycidyl ether epoxy resin and the bifunctional poly(arylene ether) exist in a single phase at 25 to 65° C. (that is, throughout the range 25 to 65° C.); wherein the curable composition has a viscosity less than or equal to 10,000 centipoise at 25° C.; wherein the composition after curing exhibits an unnotched Izod impact strength 5 to about 50% greater than that of a corresponding composition with a monofunctional poly(arylene ether), wherein unnotched Izod impact strength is measured at 25° C. according to ASTM D4812; and wherein the composition after curing exhibits a notched Izod impact strength 5 to about 30% greater than that of a corresponding composition with a monofunctional poly(arylene ether), wherein notched Izod impact strength is measured at 25° C. according to ASTM D256.

One embodiment is a curable composition, consisting of: about 60 to about 90 parts by weight of a bisphenol A diglycidyl ether epoxy resin; about 10 to about 40 parts by weight of a bifunctional poly(arylene ether) having an intrinsic viscosity of about 0.06 to about 0.12 deciliter per gram, measured in chloroform at 25° C., wherein the poly(arylene ether) has the structure

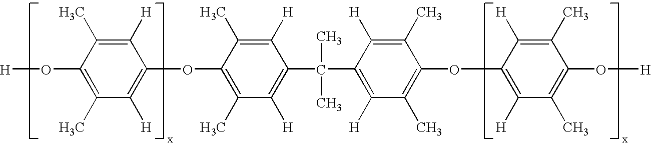

wherein each occurrence of x is independently 1 to about 20; and about 0.5 to about 10 parts by weight of aluminum (III) acetylacetonate; optionally, about 20 to about 100 parts by weight percent of a filler; and optionally, an additive selected from dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, substrate adhesion agents, mold release agents, toughening agents, low-profile additives, stress-relief additives, and combinations thereof; wherein the bisphenol A diglycidyl ether epoxy resin and the bifunctional poly(arylene ether) exist in a single phase at 25 to 65° C. (that is, throughout the range 25 to 65° C.); wherein all parts by weight are based on 100 parts by weight total of the epoxy resin and the bifunctional poly(arylene ether); wherein the composition after curing exhibits an unnotched Izod impact strength 5 to about 50% greater than that of a corresponding composition with a monofunctional poly(arylene ether), wherein unnotched Izod impact strength is measured at 25° C. according to ASTM D4812; and wherein the composition after curing exhibits a notched Izod impact strength 5 to about 30% greater than that of a corresponding composition with a monofunctional poly(arylene ether), wherein notched Izod impact strength is measured at 25° C. according to ASTM D256.

One embodiment is a curable composition, comprising: about 60 to about 90 parts by weight of a bisphenol A diglycidyl ether epoxy resin; about 10 to about 40 parts by weight of a bifunctional poly(arylene ether) having an intrinsic viscosity of about 0.06 deciliter per gram, measured in chloroform at 25° C., wherein the poly(arylene ether) has the structure

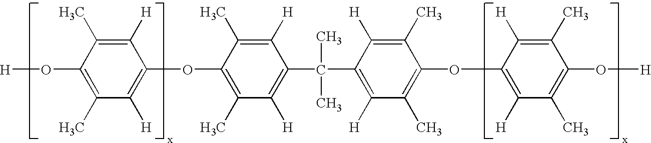

wherein each occurrence of x is independently 1 to about 20; and about 0.5 to about 10 parts by weight of aluminum (III) acetylacetonate; wherein the bisphenol A diglycidyl ether epoxy resin and the bifunctional poly(arylene ether) exist in a single phase at 25 to 65° C.; wherein all parts by weight are based on 100 parts by weight total of the epoxy resin and the bifunctional poly(arylene ether); wherein the composition after curing exhibits an unnotched Izod impact strength 5 to about 50% greater than that of a corresponding composition with a monofunctional poly(arylene ether), wherein unnotched Izod impact strength is measured at 25° C. according to ASTM D4812; and wherein the composition after curing exhibits a notched Izod impact strength 5 to about 30% greater than that of a corresponding composition with a monofunctional poly(arylene ether), wherein notched Izod impact strength is measured at 25° C. according to ASTM D256.

Another embodiment is a curable composition, comprising: about 60 to about 90 parts by weight of a bisphenol A diglycidyl ether epoxy resin; about 10 to about 40 parts by weight of a bifunctional poly(arylene ether) having an intrinsic viscosity of about 0.09 deciliter per gram, measured in chloroform at 25° C., wherein the poly(arylene ether) has the structure

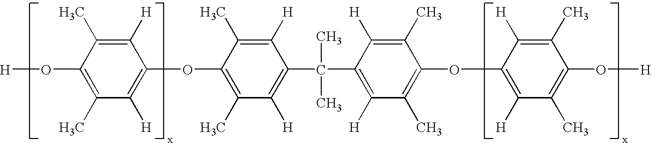

wherein each occurrence of x is independently 1 to about 20; and about 0.5 to about 10 parts by weight of aluminum (III) acetylacetonate; wherein the bisphenol A diglycidyl ether epoxy resin and the bifunctional poly(arylene ether) exist in a single phase at 25 to 65° C.; wherein all parts by weight are based on 100 parts by weight total of the epoxy resin and the bifunctional poly(arylene ether); wherein the composition after curing exhibits an unnotched Izod impact strength 5 to about 50% greater than that of a corresponding composition with a monofunctional poly(arylene ether), wherein unnotched Izod impact strength is measured at 25° C. according to ASTM D4812; and wherein the composition after curing exhibits a notched Izod impact strength 5 to about 30% greater than that of a corresponding composition with a monofunctional poly(arylene ether), wherein notched Izod impact strength is measured at 25° C. according to ASTM D256.

Another embodiment is a curable composition, comprising: about 60 to about 90 parts by weight of a bisphenol A diglycidyl ether epoxy resin; about 10 to about 40 parts by weight of a bifunctional poly(arylene ether) having an intrinsic viscosity of about 0.12 deciliter per gram, measured in chloroform at 25° C., wherein the poly(arylene ether) has the structure

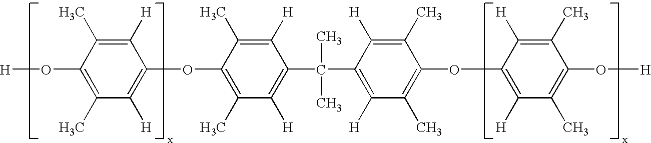

wherein each occurrence of x is independently 1 to about 20; and about 0.5 to about 10 parts by weight of aluminum (III) acetylacetonate; wherein the bisphenol A diglycidyl ether epoxy resin and the bifunctional poly(arylene ether) exist in a single phase at 25 to 65° C.; wherein all parts by weight are based on 100 parts by weight total of the epoxy resin and the bifunctional poly(arylene ether); wherein the composition after curing exhibits an unnotched Izod impact strength 5 to about 50% greater than that of a corresponding composition with a monofunctional poly(arylene ether), wherein unnotched Izod impact strength is measured at 25° C. according to ASTM D4812; and wherein the composition after curing exhibits a notched Izod impact strength 5 to about 30% greater than that of a corresponding composition with a monofunctional poly(arylene ether), wherein notched Izod impact strength is measured at 25° C. according to ASTM D256.

One embodiment is a method of preparing a curable composition, comprising: blending an epoxy resin, a bifunctional poly(arylene ether) having an intrinsic viscosity of about 0.03 to about 0.2 deciliter per gram, measured in chloroform at 25° C., and an amount of a curing promoter effective to cure the epoxy resin; wherein the composition after curing exhibits an unnotched Izod impact strength at least 5% greater than that of a corresponding composition with a monofunctional poly(arylene ether), wherein unnotched Izod impact strength is measured at 25° C. according to ASTM D4812. In some embodiments, the composition comprises forming a single phase comprising the epoxy resin and the bifunctional poly(arylene ether) by heating to a temperature less than or equal to 100° C.

Conditions suitable for curing the curable composition will depend on factors including the identity and concentration of the epoxy resin, and the identity and amount of the curing promoter. Suitable curing conditions may include exposure to a temperature of about 120 to about 250° C. for a time of about 10 minutes to about 24 hours. Within the above time range, the curing temperature may be at least about 150° C., or at least about 180° C., or at least about 210° C. As demonstrated in the working examples below, curing may be conducted in a series of two or more steps at different temperatures. One skilled in the thermoset arts is capable of determining suitable curing conditions without undue experimentation. In some embodiments, the composition may be partially cured. However, references herein to properties of the “cured composition” or the “composition after curing” generally refer to compositions that are substantially fully cured. One skilled in the thermoplastic arts may determine whether a sample is substantially fully cured without undue experimentation. For example, one may analyze the sample by differential scanning calorimetry to look for an exotherm indicative of additional curing occurring during the analysis. A sample that is substantially fully cured will exhibit little or no exotherm in such an analysis.

The invention extends to cured compositions obtained on curing any of the above described compositions. The invention also extends to articles comprising such cured compositions. The cured compositions are particularly suitable for use in the fabrication of electronic laminates, prepregs, and circuit boards. The compositions may also be utilized in vanishes, encapsulants, structural composites, powder and liquid coatings, and high temperature adhesives.

The invention is further illustrated by the following non-limiting examples.

### EXAMPLES 1-10, COMPARATIVE EXAMPLES 1-12

Ten inventive examples illustrating the use of bifunctional low molecular weight poly(arylene ethers) in an epoxy resin were compared to seven comparative examples illustrating the use of monofunctional low molecular weight poly(arylene ethers) in an epoxy resin, four comparative examples illustrating the use of nonfunctional low molecular weight poly(arylene ethers) in an epoxy resin, and one comparative example with just the epoxy resin. The bisphenol A diglycidyl ether (“BPA Epoxy”) was obtained as DER 332 epoxy resin from the Dow Chemical Company. The three bifunctional poly(arylene ether) resins are designated “PPE, 0.12, bifxl.”, “PPE, 0.09, bifxl.”, and “PPE, 0.06, bifxl.”, wherein “0.12”, “0.09”, and “0.06” refer to the intrinsic viscosity of the resin, in deciliters per gram. The two monofunctional poly(arylene ether) resins are designated “PPE, 0.12 monofxl.” and “PPE, 0.12 monofxl.”, while the nonfunctional, acetic anhydride-capped resin, is designated “PPE, 0.06 nonfxl.”.

The bifunctional poly(arylene ether) resins were prepared by oxidative copolymerization of 2,6-dimethylphenol and 2,2-bis(3,5-dimethyl-4-hydroxy)propane to form a copolymer having the desired intrinsic viscosity and approximately two hydroxyl groups per molecule. A detailed procedure for this method is described in U.S. patent application Ser. No. 11/298,182, filed Dec. 20, 2005.

The monofunctional poly(arylene ether) resins were prepared by homopolymerization of 2,6-dimethylphenol to form a poly(2,6-dimethyl-1,4-phenylene ether) having the desired intrinsic viscosity and approximately one hydroxyl group per molecule.

The “nonfunctional” (acetate capped) poly(arylene ether) was prepared by the same process used for preparation of the 0.06 deciliter per gram (dL/g) monofunctional poly(arylene ether) except that the hydroxyl groups of the product poly(2,6-dimethyl-1,4-phenylene ether) were acetate capped by reaction with acetic anhydride in the presence of 4-(dimethylamino)pyridine catalyst as follows. A monofunctional, 0.06 dL/g poly(2,6-dimethyl-1,4-phenylene ether) (1500 grams) was dissolved in 1100 grams of toluene at 80° C., and 30 grams of 4-(dimethylamino)pyridine and 300 grams of acetic anhydride were added. After stirring for 6 hours the solution was cooled and Resin C was isolated by precipitation in methanol and dried.

Intrinsic viscosities were measured at 25° C. in chloroform on poly(arylene ether) samples that had been dried for 1 hour at 125° C. under vacuum.

Molecular weight distributions were determined by gel permeation chromatography (GPC). The chromatographic system consisted of an Agilent Series 1100 system, including isocratic pump, autosampler, thermostatted column compartment, and multi-wavelength detector. The elution solvent was chloroform with 50 parts per million by weight of di-n-butylamine. Sample solutions were prepared by dissolving 0.01 gram of sample in 20 milliliters chloroform with toluene (0.25 milliliter per liter) as an internal marker. The sample solutions were filtered through a Gelman 0.45 micrometer syringe filter before GPC analysis; no additional sample preparation was performed. The injection volume was 50 microliters and the eluent flow rate was set at 1 milliliter/minute. Two Polymer Laboratories GPC columns (Phenogel 5 micron linear(2), 300×7.80 millimeters) connected in series were used for separation of the sample. The detection wavelength was set at 280 nanometers. The data were acquired and processed using an Agilent ChemStation with integrated GPC data analysis software. The molecular weight distribution results were calibrated with polystyrene standards. The results are reported without any correction as “Mₙ (AMU)” and “M_{w} (AMU)”.

Glass transition temperatures (T_{g}) were determined by dynamic mechanical analysis (DMA) using a Perkin Elmer DMA 7e instrument and a heating rate of 5 degrees C./minute.

The poly(arylene ether)s were analyzed by proton nuclear magnetic resonance spectroscopy (¹H NMR) to determine the absolute number average molecular weight and the concentration of hydroxyl end groups (in parts per million by weight). The relative amounts of internal units (including 2,6-dimethyl-1,4-phenylene ether units, divalent groups derived from 3,3′,5,5′-tetramethyl-4,4′-biphenol, and divalent units derived from 2,2-bis(3,5-dimethyl-4-hydroxy)propane) and terminal units (including 2,6-dimethyl-1-hydroxy-phen-4-yl units, 2,6-dimethyl-phen-1-yl units, monovalent phenolic units derived from 2,2-bis(3,5-dimethyl-4-hydroxy)propane, and monovalent dibutylamine-substituted phenolic groups derived from 2,6-dimethylphenol and dibutylamine catalyst) were determined by integrating the associated resonances and adjusting for the number of protons giving rise to the resonance. Values of number average molecular weight were then calculated based on the relative amounts of internal units and total terminal units. Values of hydroxyl end group content were calculated based on the relative amounts of terminal phenolic groups and total terminal and internal units. Values of hydroxyl (OH) group content are expressed in parts per million by weight (ppm), where the hydroxyl groups were assigned a molecular weight of 17 grams per mole. “Functionality” is the average number of hydroxyl groups per molecule of poly(arylene ether). Functionality is calculated according to the formula

Functionality=2*mol OH-endgroups/(mol of all endgroups)

where “mol OH-endgroups” is the moles of hydroxyl endgroups, and “mol of all endgroups” is the moles of all endgroups, which includes hydroxyl endgroups and so-called “tail groups” which in this case are 2,6-dimethylphenyl groups.

Poly(arylene ether) properties are summarized in Table 1. The functionality value of zero for the nonfunctional resin is based on a hydroxyl content upper limit of 50 ppm, determined by Fourier Transform Infrared spectroscopy (FTIR) with 2,6-dimethylphenol standards.

TABLE 1

| | PPE, 0.12, | PPE, 0.09, | PPE, 0.06, |
|---|---|---|---|
| | bifxl. | bifxl. | bifxl. |
| IV (dL/g) | 0.116 | 0.087 | 0.067 |
| Mₙ (AMU) | 1921 | 1198 | 799 |
| M_{w} (AMU) | 4378 | 2477 | 1690 |
| M_{w}/Mₙ | 2.28 | 2.07 | 2.12 |
| T_{g} (° C.) | 147.8 | 115.8 | 99.6 |
| Absolute Mₙ | 2747 | 1551 | 1183 |
| Hydroxyl content (ppm) | 11900 | 21800 | 28200 |
| Functionality | 1.9 | 1.91 | 1.92 |
| | PPE, 0.12, | PPE, 0.06, | PPE, 0.06, |
| | monofxl. | monofxl. | nonfxl. |
| IV (dL/g) | 0.124 | 0.062 | .064 |
| Mₙ (AMU) | 1964 | 886 | — |
| M_{w} (AMU) | 5148 | 1873 | — |
| M_{w}/Mₙ | 2.62 | 2.11 | — |
| T_{g} (° C.) | 157.9 | 95.9 | |
| Absolute Mₙ | 2294 | 1133 | — |
| Hydroxyl content (ppm) | 8400 | 16000 | — |
| Functionality | 1.12 | 1.05 | 0 |

All curable compositions were prepared by dissolving the poly(arylene ether), if any, in BPA epoxy resin at 90° C. Next, a curing promoter, aluminum acetylacetonate (obtained from Acros Organics, catalog number AC19697), was added and mixed thoroughly. The mixture was degassed at 100° C. and 7.4 kilopascals (kPa), and then poured into the mold, which was preheated to 100° C. The filled mold was placed in an oven at 150° C. for 90 minutes. The oven temperature was then increased to 175° C. After 60 minutes, the temperature was increased to 200° C. After another 60 minutes, the oven temperature was increased to 220° C. After another 60 minutes the oven was turned oven off and the mold was allowed to cool overnight to room temperature inside the oven. The cured plaque was removed from the mold and cut into test specimens. The specimen thickness is 3.175 millimeters (⅛ inch). The cutter make is a diamond-wheeled wet saw obtained as 158189 MK-100 Tile Saw from MK Diamond Products, Inc. The Blade is a MK-225, 25.4 centimeter (10 inch) diameter diamond blade with a thickness of 1.27 millimeters (0.05 inches). In order to minimize any chipping along the cutting edge, the samples were placed on a plastic or wood backing material when cutting. All compositions are summarized in Table 2, where all component amounts are expressed in parts by weight (pbw).

Densities were measured according to ASTM D792-00, Method A, in water at 23° C.

Heat deflection temperature values, expressed in degrees centigrade, were measured automatically according to ASTM D 648-06, Method B, using a 0.45 megapascal force on samples having a width of 1.27 centimeters (0.5 inch) and a depth of 3.175 millimeters (0.125 inch). The immersion medium was silicone fluid. Tests were conducted by heating the immersion medium, initially at a temperature of 23° C., at a rate of 2° C. per minute.

Unnotched Izod impact strength values, expressed in joules per meter (J/m), were measured at 23° C. according to ASTM D 4812-06, using samples having a width of 1.27 centimeters (0.5 inch) and a thickness of 3.175 millimeters (0.125 inch). The samples were cut from the molded bars described above. The apparatus used had a pendulum with a 0.907 kilogram (2 pound) hammer.

Notched Izod impact strength was measured according to ASTM D 256-06, Method A, at 23° C. using a 0.907 kilogram (2.00 pound) hammer, and specimens having a notch such that at least 1.02 centimeter (0.4 inch) of the original 1.27 centimeter (0.5 inch) depth remained under the notch. The specimens were conditioned for 24 hours at 23° C. after notching.

Dielectric constant (“Dk”) values and dissipation factor (“Df”) values were measured at 23° C. according to ASTM D 150-98(2004). Samples were rectangular prisms having dimensions 5 centimeters by 5 centimeters by 3.175 millimeters. Samples were conditioned at 23° C. and 50% relative humidity for a minimum of twelve hours before testing. The measuring cell was a Hewlett-Packard Impedance Material Analyzer model 4291B and had dimensions 27.5 centimeters wide by 9.5 centimeters high by 20.5 centimeters deep. The electrodes were Hewlett-Packard Model 16453A and were 7 millimeters in diameter. Measurements were conducted using a capacitance method sweeping a range of frequency when DC voltage is applied to the dielectric materials. The applied voltage was 0.2 mV (rms) to IV (rms) at the frequency range of 1 MHz to 1 Ghz. In Table 2, dielectric constant and dissipation factor values are reported at frequencies of 100 megahertz, 500 megahertz, and 1 gigahertz.

Property values are summarized in Table 2.

TABLE 2

| | C. Ex. 1 | Ex. 1 | C. Ex. 2 | Ex. 2 | C. Ex. 3 | Ex. 3 | C. Ex. 4 | Ex. 4 |
|---|---|---|---|---|---|---|---|---|
| Compositions | | | | | | | | |
| BPA epoxy | 100 | 90 | 90 | 80 | 80 | 70 | 70 | 90 |
| PPE, 0.12, bifxl. | 0 | 10 | 0 | 20 | 0 | 30 | 0 | 0 |
| PPE, 0.12, monofxl. | 0 | 0 | 10 | 0 | 20 | 0 | 30 | 0 |
| PPE, 0.06, bifxl. | 0 | 0 | 0 | 0 | 0 | 0 | 0 | 10 |
| PPE, 0.06, monofxl. | 0 | 0 | 0 | 0 | 0 | 0 | 0 | 0 |
| PPE, 0.06, nonfxl. | 0 | 0 | 0 | 0 | 0 | 0 | 0 | 0 |
| PPE, 0.09, bifxl. | 0 | 0 | 0 | 0 | 0 | 0 | 0 | 0 |
| Aluminum | 2.5 | 2.5 | 2.5 | 2.5 | 2.5 | 2.5 | 2.5 | 2.5 |
| acetylacetonate | | | | | | | | |
| Properties | | | | | | | | |
| Density (g/cm³) | 1.1883 | 1.1785 | 1.1698 | 1.1674 | 1.1587 | 1.1811 | 1.1570 | 1.1784 |
| T_{g} (° C.) | 138 | 144 | 142 | 151 | 147 | 157 | 152 | — |
| HDT @ 0.45 MPa (° C.) | 144 | 150 | 149 | 156 | 154 | 162 | 159 | 147 |
| Unnotched Izod (J/m) | 94 | 140 | 111 | 179 | 128 | 218 | 144 | 121.4 |
| Notched Izod (J/m) | 34.7 | 41.2 | 38.3 | 47.4 | 44.2 | 53.4 | 48.5 | 38.1 |
| Dₖ @ 100 MHz | 2.96 | 2.933 | 2.940 | 2.913 | 2.910 | 2.861 | 2.872 | 2.904 |
| Dₖ @ 500 MHz | 2.90 | 2.853 | 2.867 | 2.821 | 2.837 | 2.797 | 2.810 | 2.840 |
| Dₖ @ 1 GHz | 2.89 | 2.824 | 2.850 | 2.787 | 2.805 | 2.754 | 2.769 | 2.807 |
| D_{f} @ 100 MHz | 0.014 | 0.013 | 0.013 | 0.011 | 0.012 | 0.011 | 0.011 | 0.013 |
| D_{f} @ 500 MHz | 0.013 | 0.012 | 0.012 | 0.011 | 0.011 | 0.011 | 0.011 | 0.013 |
| D_{f} @ 1 GHz | 0.013 | 0.012 | 0.012 | 0.010 | 0.011 | 0.009 | 0.010 | 0.012 |

| | C. Ex. 5 | C. Ex. 6 | Ex. 5 | C. Ex. 7 | C. Ex. 8 | Ex. 6 | C. Ex. 9 |
|---|---|---|---|---|---|---|---|
| Compositions | | | | | | | |
| BPA epoxy | 90 | 90 | 80 | 80 | 80 | 70 | 70 |
| PPE, 0.12, bifxl. | 0 | 0 | 0 | 0 | 0 | 0 | 0 |
| PPE, 0.12, monofxl. | 0 | 0 | 0 | 0 | 0 | 0 | 0 |
| PPE, 0.06, bifxl. | 0 | 0 | 20 | 0 | 0 | 30 | 0 |
| PPE, 0.06, monofxl. | 10 | 0 | 0 | 20 | 0 | 0 | 30 |
| PPE, 0.06, nonfxl. | 0 | 10 | 0 | 0 | 20 | 0 | 0 |
| PPE, 0.09, bifxl. | 0 | 0 | 0 | 0 | 0 | 0 | 0 |
| Aluminum | 2.5 | 2.5 | 2.5 | 2.5 | 2.5 | 2.5 | 2.5 |
| acetylacetonate | | | | | | | |
| Properties | | | | | | | |
| Density (g/cm³) | 1.1787 | — | 1.1670 | 1.1692 | — | 1.1581 | 1.1615 |
| T_{g} (° C.) | — | — | — | — | — | — | — |
| HDT @ 0.45 MPa (° C.) | 146 | 147 | 151 | 150 | 143 | 156 | 154 |
| Unnotched Izod (J/m) | 108.6 | 147.8 | 143.5 | 125.4 | 135.3 | 169.1 | 145.1 |
| Notched Izod (J/m) | 35.6 | 18.9 | 41.6 | 38.1 | 25.4 | 45.0 | 40.5 |
| Dₖ @ 100 MHz | 2.917 | — | 2.875 | 2.893 | — | 2.846 | 2.852 |
| Dₖ @ 500 MHz | 2.845 | — | 2.817 | 2.826 | — | 2.790 | 2.800 |
| Dₖ @ 1 GHz | 2.816 | — | 2.786 | 2.801 | — | 2.768 | 2.780 |
| D_{f} @ 100 MHz | 0.013 | — | 0.012 | 0.011 | — | 0.011 | 0.010 |
| D_{f} @ 500 MHz | 0.012 | — | 0.012 | 0.011 | — | 0.011 | 0.010 |
| D_{f} @ 1 GHz | 0.012 | — | 0.011 | 0.011 | — | 0.010 | 0.010 |

| | C. Ex. | | C. Ex. | C. Ex. | | | |
|---|---|---|---|---|---|---|---|
| | 10 | Ex. 7 | 11 | 12 | Ex. 8 | Ex. 9 | Ex. 10 |
| Compositions | | | | | | | |
| BPA epoxy | 70 | 60 | 60 | 60 | 90 | 80 | 70 |
| PPE, 0.12, bifxl. | 0 | 0 | 0 | 0 | 0 | 0 | 0 |
| PPE, 0.12, monofxl. | 0 | 0 | 0 | 0 | 0 | 0 | 0 |
| PPE, 0.06, bifxl. | 0 | 40 | 0 | 0 | 0 | 0 | 0 |
| PPE, 0.06, monofxl. | 0 | 0 | 40 | 0 | 0 | 0 | 0 |
| PPE, 0.06, nonfxl. | 30 | 0 | 0 | 40 | 0 | 0 | 0 |
| PPE, 0.09, bifxl. | 0 | 0 | 0 | 0 | 10 | 20 | 30 |
| Aluminum | 2.5 | 2.5 | 2.5 | 2.5 | 2.5 | 2.5 | 2.5 |
| acetylacetonate | | | | | | | |
| Properties | | | | | | | |
| Density (g/cm³) | — | 1.1494 | 1.1549 | — | 1.1772 | 1.1676 | 1.1568 |
| T_{g} (° C.) | — | — | — | — | 152 | 157 | 158 |
| HDT @ 0.45 MPa (° C.) | 138 | 158 | 157 | 132 | 149 | 154 | 160 |
| Unnotched Izod (J/m) | 113.2 | 199.5 | 155.2 | 50.1 | 147.7 | 186.4 | 209.2 |
| Notched Izod (J/m) | 29.1 | 47.1 | 42.1 | 17.7 | 39.5 | 45.4 | 49.5 |
| Dₖ @ 100 MHZ | — | 2.806 | 2.799 | — | 2.94 | 2.92 | 2.89 |
| Dₖ @ 500 MHz | — | 2.752 | 2.745 | — | 2.87 | 2.85 | 2.83 |
| Dₖ @ 1 GHz | — | 2.736 | 2.731 | — | 2.82 | 2.81 | 2.79 |
| D_{f} @ 100 MHZ | — | 0.010 | 0.009 | — | 0.012 | 0.012 | 0.011 |
| D_{f} @ 500 MHZ | — | 0.010 | .009 | — | 0.012 | 0.012 | 0.010 |
| D_{f} @ 1 GHZ | — | 0.009 | 0.009 | — | 0.010 | 0.010 | 0.009 |

With the poly(arylene ether) intrinsic viscosity held constant at 0.12 dL/g, the effects of poly(arylene ether) type (monofunctional versus bifunctional) and amount (10, 20, and 30 parts by weight per 100 parts by weight total of epoxy and poly(arylene ether)) are evident from comparisons of Examples 1-3 and Comparative Examples 1-4. Comparative Example 1 contains cured epoxy resin with no poly(arylene ether). At equivalent poly(arylene ether) levels, the data show that the epoxy resins that contain the bifunctional poly(arylene ether) with 0.12 dL/g (Examples 1-3) exhibit better properties than the epoxy resins made using the monofunctional poly(arylene ethers) (Comparative Examples 2-4). Specifically, unnotched Izod impact strengths are substantially and unexpectedly improved, and significant improvements are seen in glass transition temperature, heat deflection temperature, notched Izod impact strength, and dielectric constants. In addition, increasing levels of bifunctional poly(arylene ether) are associated with improvements in glass transition temperature (T_{g}), heat deflection temperature (HDT), unnotched and notched Izod impact strengths, dielectric constants (Dk), and dissipation factors (Df).

With the poly(arylene ether) intrinsic viscosity held constant at 0.06 dL/g, the effects of poly(arylene ether) type (nonfunctional versus monofunctional versus bifunctional) and amount (10, 20, 30, and 40 parts by weight per 100 parts by weight total of epoxy and poly(arylene ether)) are evident from comparisons of Examples 4-7 and Comparative Examples 5-12. At equivalent poly(arylene ether) levels, the data show that the epoxy resin compositions that contain the 0.06 bifunctional poly(arylene ether) (Examples 4-7) exhibit better properties than the epoxy resin compositions made using the monofunctional poly(arylene ethers) (Comparative Examples 5, 7, 9, and 11), and significantly better properties than the epoxy resin compositions containing greater than 10 weight percent nonfunctional poly(arylene ethers) (Comparative Examples 8, 10, and 12). Specifically, in Examples 4-7 containing the bifunctional poly(arylene ether), unnotched Izod impact strengths are substantially and unexpectedly improved, and significant improvements are seen in glass transition temperature, heat deflection temperature, and notched Izod impact strength. Dielectric constants were improved (reduced) for samples containing 10, 20, or 30 parts by weight poly(arylene ether). In addition, increasing levels of bifunctional poly(arylene ether) are associated with improvements in glass transition temperature, heat deflection temperature, unnotched and notched Izod impact strengths, dielectric constants, and dissipation factors. In contrast, increasing levels of the nonfunctional poly(arylene ether) are associated with decreasing heat deflection temperatures.

Examples 8, 9, and 10 illustrate compositions and properties of inventive compositions with 0.09 dL/g bifunctional poly(arylene ether). Increasing levels of bifunctional poly(arylene ether) are associated with improvements in glass transition temperature, heat deflection temperature, unnotched and notched Izod impact strengths, dielectric constants, and dissipation factors.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

1. A curable composition, comprising:
an epoxy resin;
a bifunctional poly(arylene ether) having an intrinsic viscosity of about 0.03 to about 0.2 deciliter per gram, measured in chloroform at 25° C.; and
an amount of a curing promoter effective to cure the epoxy resin;
wherein the composition after curing exhibits an unnotched Izod impact strength at least 5% greater than that of a corresponding composition with a monofunctional poly(arylene ether), wherein unnotched Izod impact strength is measured at 25° C. according to ASTM D4812.

2. The curable composition of claim 1, wherein the composition after curing exhibits an unnotched Izod impact strength 5 to about 50% greater than that of a corresponding composition with a monofunctional poly(arylene ether).

3. The curable composition of claim 1, wherein the composition after curing exhibits a notched Izod impact strength at least 5% greater than that of a corresponding composition with a monofunctional poly(arylene ether), wherein notched Izod impact strength is measured at 25° C. according to ASTM D256.

4. The curable composition of claim 3, wherein the composition after curing exhibits a notched Izod impact strength 5 to about 30% greater than that of a corresponding composition with a monofunctional poly(arylene ether).

5. The curable composition of claim 1, wherein the epoxy resin has a softening point of about 25° C. to about 150° C.

6. The curable composition of claim 1, wherein the epoxy resin has a softening point less than 25° C.

7. The curable composition of claim 1, wherein the epoxy resin is selected from the group consisting of aliphatic epoxy resins, cycloaliphatic epoxy resins, bisphenol-A epoxy resins, bisphenol-F epoxy resins, phenol novolac epoxy resins, cresol-novolac epoxy resins, biphenyl epoxy resins, polyfunctional epoxy resins, naphthalene epoxy resins, divinylbenzene dioxide, 2-glycidylphenylglycidyl ether, dicyclopentadiene-type epoxy resins, multi aromatic resin type epoxy resins, and combinations thereof.

8. The curable composition of claim 1, wherein the epoxy resin comprises a monomeric epoxy resin and an oligomeric epoxy resin.

9. The curable composition of claim 1, wherein the epoxy resin comprises a bisphenol A diglycidyl ether epoxy resin.

10. The curable composition of claim 1, wherein the bifunctional poly(arylene ether) has the structure 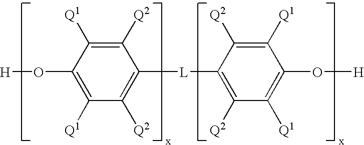
wherein each occurrence of Q¹ and Q² is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of x is independently 1 to about 100; and L has the structure 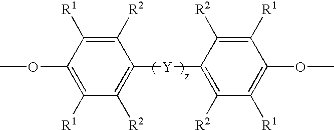
wherein each occurrence of R¹ and R² is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; z is 0 or 1; and Y has a structure selected from the group consisting of 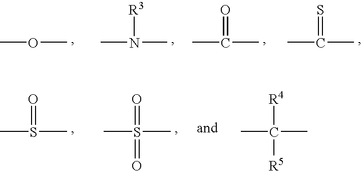
wherein each occurrence of R³ is independently selected from the group consisting of hydrogen and C₁-C₁₂ hydrocarbyl, and each occurrence of R⁴ and R⁵ is independently selected from the group consisting of hydrogen, C₁-C₁₂ hydrocarbyl, and C₁-C₆ hydrocarbylene wherein R⁴ and R⁵ collectively form a C₄-C₁₂ alkylene group.

11. The curable composition of claim 1, wherein the bifunctional poly(arylene ether) has the structure 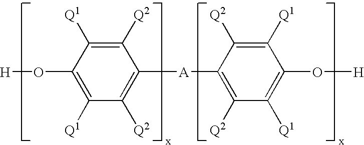
wherein each occurrence of Q¹ and Q² is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; each occurrence of x is independently 1 to about 100; and A has the structure 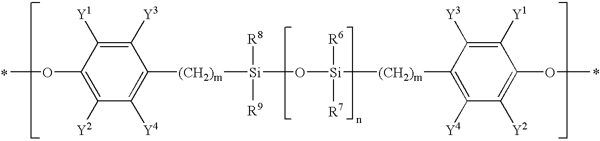
wherein each occurrence of R⁶ and R⁷ and R⁸ and R⁹ is independently hydrogen, C₁-C₁₂ hydrocarbyl or C₁-C₁₂ halohydrocarbyl; wherein each occurrence of m is independently 0, 1, 2, 3, 4, 5, or 6; and wherein each occurrence of Y¹ and Y² and Y³ and Y⁴ is independently hydrogen, C₁-C₁₂ hydrocarbyl, C₁-C₁₂ hydrocarbyloxy, or halogen; and wherein n is 5 to about 200.

12. The curable composition of claim 11, wherein each occurrence of Q¹ is methyl, wherein each occurrence of Q² is hydrogen or methyl, wherein each occurrence of Y¹ is methoxy, wherein each occurrence of Y² and Y³ and Y⁴ is hydrogen, wherein each occurrence of R⁶ and R⁷ and R⁸ and R⁹ is methyl, wherein each occurrence of m is 3, and wherein n is about 10 to about 100.

13. The curable composition of claim 1, wherein the bifunctional poly(arylene ether) has the structure 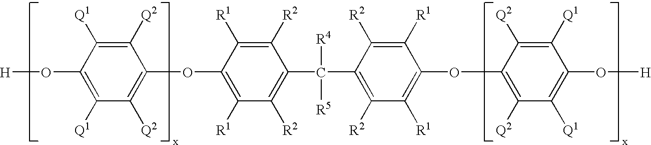
wherein Q¹ is methyl; each occurrence of Q² is independently hydrogen or methyl; each occurrence of R¹ and R² is independently hydrogen, halogen, unsubstituted or substituted C₁-C₁₂ hydrocarbyl with the proviso that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; R⁴ and R⁵ are each independently selected from the group consisting of hydrogen, C₁-C₆ hydrocarbyl, and C₁-C₆ hydrocarbylene wherein R⁴ and R⁵ collectively form a C₄-C₁₂ alkylene group; and each occurrence of x is independently 1 to about 50.

14. The curable composition of claim 1, wherein the bifunctional poly(arylene ether) has the structure 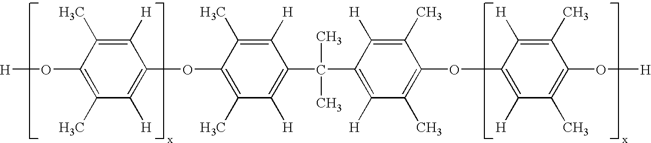
wherein each occurrence of x is independently 1 to about 20.

15. The curable composition of claim 1, wherein the bifunctional poly(arylene ether) is the product of oxidative copolymerization of a monohydric phenol and a dihydric phenol.

16. The curable composition of claim 12, wherein the monohydric phenol is selected from the group consisting of 2,6-dimethylphenol, 2,3,6-trimethylphenol, and mixtures thereof; and wherein the dihydric phenol is selected from the group consisting of 3,3′,5,5′-tetramethyl-4,4′-biphenol, 2,2-bis(3-methyl-4-hydroxyphenyl)propane, 2,2-bis(3,5-dimethyl-4-hydroxyphenyl)propane, 1,1-bis(4-hydroxyphenyl)methane, 1,1-bis(4-hydroxyphenyl)ethane, 2,2-bis(4-hydroxyphenyl)propane 2,2-bis(4-hydroxyphenyl)butane, 2,2-bis(4-hydroxyphenyl)octane, 1,1-bis(4-hydroxyphenyl)propane, 1,1-bis(4-hydroxyphenyl)-n-butane, bis(4-hydroxyphenyl)phenylmethane, 1,1-bis(4-hydroxy-3-methylphenyl)cyclohexane, 1,1-bis(4-hydroxy-3,5-dimethylphenyl)cyclopentane, 1,1-bis(4-hydroxy-3,5-dimethylphenyl)cyclohexane, 1,1-bis(4-hydroxy-3-methylphenyl)cycloheptane, 1,1-bis(4-hydroxy-3,5-dimethylphenyl)cycloheptane, 1,1-bis(4-hydroxy-3-methylphenyl)cyclooctane, 1,1-bis(4-hydroxy-3,5-dimethylphenyl)cyclooctane, 1,1-bis(4-hydroxy-3-methylphenyl)cyclononane, 11,1-bis(4-hydroxy-3,5-dimethylphenyl)cyclononane, 1,1-bis(4-hydroxy-3-methylphenyl)cyclodecane, 1,1-bis(4-hydroxy-3,5-dimethylphenyl)cyclodecane, 1,1-bis(4-hydroxy-3-methylphenyl)cycloundecane, 1,1-bis(4-hydroxy-3,5-dimethylphenyl)cycloundecane, 1,1-bis(4-hydroxy-3-methylphenyl)cyclododecane, 1,1-bis(4-hydroxy-3,5-dimethylphenyl)cyclododecane, 1,1-bis(4-hydroxy-3-t-butylphenyl)propane, 2,2-bis(4-hydroxy-2,6-dimethylphenyl)propane 2,2-bis(4-hydroxy-3-bromophenyl)propane, 1,1-bis(4-hydroxyphenyl)cyclopentane, 1,1-bis(4-hydroxyphenyl)cyclohexane, and mixtures thereof.

17. The curable composition of claim 12, wherein the monohydric phenol is 2,6-dimethylphenol, and wherein the dihydric phenol is 2,2-bis(3,5-dimethyl-4-hydroxyphenyl)propane.

18. The curable composition of claim 12, wherein the monohydric phenol is 2,6-dimethylphenol, and wherein the dihydric phenol is selected from the group consisting of 2,2-bis(3-methyl-4-hydroxyphenyl)propane, 1,1-bis(4-hydroxy-3-methylphenyl)cyclohexane, 1,1-bis(4-hydroxy-3,5-dimethylphenyl)cyclohexane, and mixtures thereof.

19. The curable composition of claim 1, comprising about 30 to about 99 parts by weight of the epoxy resin and about 1 to about 70 parts by weight of the bifunctional poly(arylene ether), wherein all parts by weight are based on 100 parts by weight total of the epoxy resin and the bifunctional poly(arylene ether).

20. The curable composition of claim 1, comprising about 60 to about 90 parts by weight of the epoxy resin and about 10 to about 40 parts by weight of the bifunctional poly(arylene ether), wherein all parts by weight are based on 100 parts by weight total of the epoxy resin and the bifunctional poly(arylene ether).

21. The curable composition of claim 1, wherein the curing promoter is selected from the group consisting of latent cationic cure catalysts, phenolic hardeners, amine hardeners, copper (II) salts of aliphatic or aromatic carboxylic acids, aluminum (III) salts of aliphatic or aromatic carboxylic acids, copper (II) β-diketonates, aluminum (III) β-diketonates, cycloaliphatic carboxylic acid anhydrides, borontrifluoride-trimethylamine complex, and combinations thereof.

22. The curable composition of claim 1, wherein the curing promoter is a latent cationic cure catalyst selected from the group consisting of diaryliodonium salts, phosphonic acid esters, sulfonic acid esters, carboxylic acid esters, phosphonic ylides, benzylsulfonium salts, benzylpyridinium salts, benzylammonium salts, isoxazolium salts, borontrifluoride-trimethylamine complex, and combinations thereof.

23. The curable composition of claim 1, wherein the curing promoter comprises aluminum (III) acetylacetonate.

24. The curable composition of claim 1, further comprising about 2 to about 50 weight percent of a filler, based on the total weight of the composition.

25. The curable composition of claim 1, wherein the composition is free of inorganic particulate filler.

26. The curable composition of claim 1, further comprising an additive selected from the group consisting of dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, substrate adhesion agents, mold release agents, toughening agents, low-profile additives, stress-relief additives, and combinations thereof.

27. A curable composition, consisting of:
an epoxy resin;
a bifunctional poly(arylene ether) having an intrinsic viscosity of about 0.03 to about 0.2 deciliter per gram, measured in chloroform at 25° C.;
an amount of a curing promoter effective to cure the epoxy resin;
optionally, about 2 to about 50 weight percent of a filler, based on the total weight of the composition; and
optionally, an additive selected from the group consisting of dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, substrate adhesion agents, mold release agents, toughening agents, low-profile additives, stress-relief additives, and combinations thereof;
wherein the composition after curing exhibits an unnotched Izod impact strength at least 5% greater than that of a corresponding composition with a monofunctional poly(arylene ether), wherein unnotched Izod impact strength is measured at 25° C. according to ASTM D4812.

28. A curable composition, comprising:
a bisphenol A diglycidyl ether epoxy resin;
a bifunctional poly(arylene ether) having an intrinsic viscosity of about 0.03 to about 0.2 deciliter per gram, measured in chloroform at 25° C., wherein the poly(arylene ether) has the structure 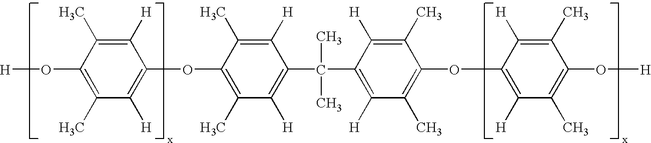
wherein each occurrence of x is independently 1 to about 20; and
an amount of a curing promoter effective to cure the epoxy resin;
wherein the composition after curing exhibits an unnotched Izod impact strength 5 to about 50% greater than that of a corresponding composition with a monofunctional poly(arylene ether), wherein unnotched Izod impact strength is measured at 25° C. according to ASTM D4812.

29. A curable composition, consisting of:
a bisphenol A diglycidyl ether epoxy resin;
a bifunctional poly(arylene ether) having an intrinsic viscosity of about 0.03 to about 0.2 deciliter per gram, measured in chloroform at 25° C., wherein the poly(arylene ether) has the structure 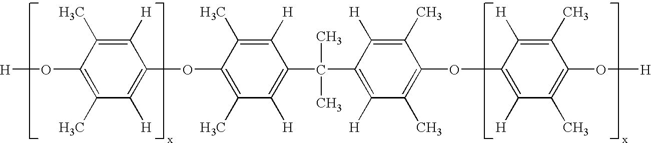
wherein each occurrence of x is independently 1 to about 20;
an amount of a curing promoter effective to cure the epoxy resin;
optionally, about 2 to about 50 weight percent of a filler, based on the total weight of the composition; and
optionally, an additive selected from the group consisting of dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, substrate adhesion agents, mold release agents, toughening agents, low-profile additives, stress-relief additives, and combinations thereof;
wherein the composition after curing exhibits an unnotched Izod impact strength 5 to about 50% greater than that of a corresponding composition with a monofunctional poly(arylene ether), wherein unnotched Izod impact strength is measured at 25° C. according to ASTM D4812.

30. A curable composition, comprising:
about 60 to about 90 parts by weight of a bisphenol A diglycidyl ether epoxy resin;
about 10 to about 40 parts by weight of a bifunctional poly(arylene ether) having an intrinsic viscosity of about 0.06 to about 0.12 deciliter per gram, measured in chloroform at 25° C., wherein the poly(arylene ether) has the structure 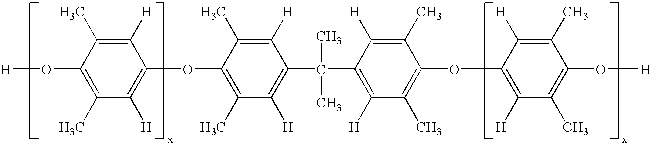
wherein each occurrence of x is independently 1 to about 20; and
about 0.5 to about 10 parts by weight of aluminum (III) acetylacetonate;
wherein all parts by weight are based on 100 parts by weight total of the epoxy resin and the bifunctional poly(arylene ether);
wherein the bisphenol A diglycidyl ether epoxy resin and the bifunctional poly(arylene ether) exist in a single phase at 25 to 65° C.;
wherein the curable composition has a viscosity less than or equal to 10,000 centipoise at 25° C.;
wherein the composition after curing exhibits an unnotched Izod impact strength 5 to about 50% greater than that of a corresponding composition with a monofunctional poly(arylene ether), wherein unnotched Izod impact strength is measured at 25° C. according to ASTM D4812; and
wherein the composition after curing exhibits a notched Izod impact strength 5 to about 30% greater than that of a corresponding composition with a monofunctional poly(arylene ether), wherein notched Izod impact strength is measured at 25° C. according to ASTM D256.

31. A curable composition, consisting of:
about 60 to about 90 parts by weight of a bisphenol A diglycidyl ether epoxy resin;
about 10 to about 40 parts by weight of a bifunctional poly(arylene ether) having an intrinsic viscosity of about 0.06 to about 0.12 deciliter per gram, measured in chloroform at 25° C., wherein the poly(arylene ether) has the structure 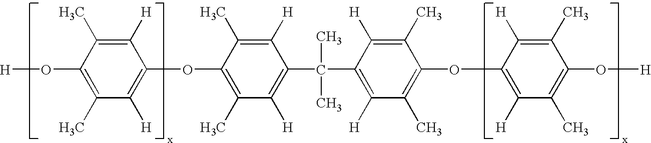
wherein each occurrence of x is independently 1 to about 20; and
about 0.5 to about 10 parts by weight of aluminum (III) acetylacetonate;
optionally, about 20 to about 100 parts by weight percent of a filler; and
optionally, an additive selected from the group consisting of dyes, pigments, colorants, antioxidants, heat stabilizers, light stabilizers, plasticizers, lubricants, flow modifiers, drip retardants, flame retardants, antiblocking agents, antistatic agents, flow-promoting agents, processing aids, substrate adhesion agents, mold release agents, toughening agents, low-profile additives, stress-relief additives, and combinations thereof;
wherein the bisphenol A diglycidyl ether epoxy resin and the bifunctional poly(arylene ether) exist in a single phase at 25 to 65° C.;
wherein all parts by weight are based on 100 parts by weight total of the epoxy resin and the bifunctional poly(arylene ether);
wherein the composition after curing exhibits an unnotched Izod impact strength 5 to about 50% greater than that of a corresponding composition with a monofunctional poly(arylene ether), wherein unnotched Izod impact strength is measured at 25° C. according to ASTM D4812; and
wherein the composition after curing exhibits a notched Izod impact strength 5 to about 30% greater than that of a corresponding composition with a monofunctional poly(arylene ether), wherein notched Izod impact strength is measured at 25° C. according to ASTM D256.

32. A curable composition, comprising:
about 60 to about 90 parts by weight of a bisphenol A diglycidyl ether epoxy resin;
about 10 to about 40 parts by weight of a bifunctional poly(arylene ether) having an intrinsic viscosity of about 0.06 deciliter per gram, measured in chloroform at 25° C., wherein the poly(arylene ether) has the structure 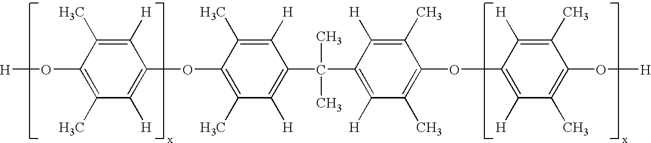
wherein each occurrence of x is independently 1 to about 20; and
about 0.5 to about 10 parts by weight of aluminum (III) acetylacetonate;
wherein the bisphenol A diglycidyl ether epoxy resin and the bifunctional poly(arylene ether) exist in a single phase at 25 to 65° C.;
wherein all parts by weight are based on 100 parts by weight total of the epoxy resin and the bifunctional poly(arylene ether);
wherein the composition after curing exhibits an unnotched Izod impact strength 5 to about 50% greater than that of a corresponding composition with a monofunctional poly(arylene ether), wherein unnotched Izod impact strength is measured at 25° C. according to ASTM D4812; and
wherein the composition after curing exhibits a notched Izod impact strength 5 to about 30% greater than that of a corresponding composition with a monofunctional poly(arylene ether), wherein notched Izod impact strength is measured at 25° C. according to ASTM D256.

33. A curable composition, comprising:
about 60 to about 90 parts by weight of a bisphenol A diglycidyl ether epoxy resin;
about 10 to about 40 parts by weight of a bifunctional poly(arylene ether) having an intrinsic viscosity of about 0.09 deciliter per gram, measured in chloroform at 25° C., wherein the poly(arylene ether) has the structure 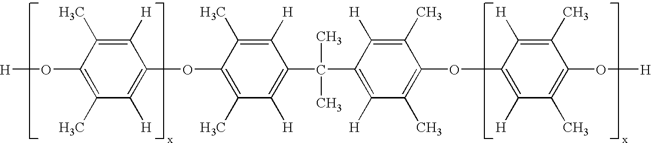
wherein each occurrence of x is independently 1 to about 20; and
about 0.5 to about 10 parts by weight of aluminum (III) acetylacetonate;
wherein the bisphenol A diglycidyl ether epoxy resin and the bifunctional poly(arylene ether) exist in a single phase at 25 to 65° C.;
wherein all parts by weight are based on 100 parts by weight total of the epoxy resin and the bifunctional poly(arylene ether);
wherein the composition after curing exhibits an unnotched Izod impact strength 5 to about 50% greater than that of a corresponding composition with a monofunctional poly(arylene ether), wherein unnotched Izod impact strength is measured at 25° C. according to ASTM D4812; and
wherein the composition after curing exhibits a notched Izod impact strength 5 to about 30% greater than that of a corresponding composition with a monofunctional poly(arylene ether), wherein notched Izod impact strength is measured at 25° C. according to ASTM D256.

34. A curable composition, comprising:
about 60 to about 90 parts by weight of a bisphenol A diglycidyl ether epoxy resin;
about 10 to about 40 parts by weight of a bifunctional poly(arylene ether) having an intrinsic viscosity of about 0.12 deciliter per gram, measured in chloroform at 25° C., wherein the poly(arylene ether) has the structure 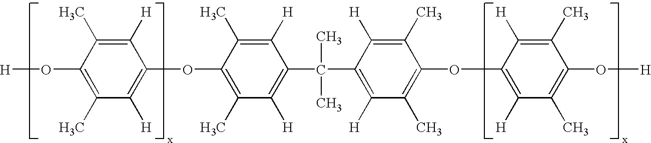
wherein each occurrence of x is independently 1 to about 20; and
about 0.5 to about 10 parts by weight of aluminum (III) acetylacetonate;
wherein the bisphenol A diglycidyl ether epoxy resin and the bifunctional poly(arylene ether) exist in a single phase at 25 to 65° C.;
wherein all parts by weight are based on 100 parts by weight total of the epoxy resin and the bifunctional poly(arylene ether);
wherein the composition after curing exhibits an unnotched Izod impact strength 5 to about 50% greater than that of a corresponding composition with a monofunctional poly(arylene ether), wherein unnotched Izod impact strength is measured at 25° C. according to ASTM D4812; and
wherein the composition after curing exhibits a notched Izod impact strength 5 to about 30% greater than that of a corresponding composition with a monofunctional poly(arylene ether), wherein notched Izod impact strength is measured at 25° C. according to ASTM D256.

35. A method of preparing a curable composition, comprising:
blending an epoxy resin,
a bifunctional poly(arylene ether) having an intrinsic viscosity of about 0.03 to about 0.2 deciliter per gram, measured in chloroform at 25° C., and an amount of a curing promoter effective to cure the epoxy resin;
wherein the composition after curing exhibits an unnotched Izod impact strength at least 5% greater than that of a corresponding composition with a monofunctional poly(arylene ether), wherein unnotched Izod impact strength is measured at 25° C. according to ASTM D4812.
